(19) United States
(12) Patent Application Publication
(10) Pub. No.: US 2007/0195065 A1
(43) Pub. Date: Aug. 23, 2007

(54) Jog-dial assisted character selection

(76) Inventor: Henning Nielsen, Struer (DK)

Correspondence Address: HARNESS, DICKEY & PIERCE, P.L.C., P.O. BOX 8910, RESTON, VA, 20195, US

(21) Appl. No.: 11/701,421

(22) Filed: Feb. 2, 2007

Related U.S. Application Data
(60) Provisional application No. 60/774,217, filed on Feb. 17, 2006.

(51) Int. Cl. G06F 3/041

(52) U.S. Cl. 345/173

(57) ABSTRACT

An apparatus such as a mobile telephone, a PDA or an electronic calendar, able to receive a string of characters, were a character or group of characters is selected by an operator performing a circular movement of a sensitive element, and where a displayed or highlighted character is subsequently selected. Also, the apparatus may have means for determining a rotation thereof and is adapted to rotate information provided on a display thereof accordingly.

### PRIORITY STATEMENT

This application claims benefit of priority under 35 U.S.C. § 119 from U.S. Patent Application No. 60/774,217 filed on Feb. 17, 2006, in the U.S. Patent Office, the disclosure of which is incorporated herein by reference in its entirety.

The present invention relates to improvements in apparatus receiving character strings from a user, such as mobile telephones, PDA's, pocket calendars, MP3-players, computers and the like.

Entering character strings has hitherto been performed using push button technology or technology emulating push buttons, such as using touch screens/pads.

It has been found more preferable to use, in the selection of the character to input, a circular movement.

In a first aspect, the invention relates to an apparatus for a user to generate a string of characters, the apparatus comprising:
a display or monitor for providing information to the user,
means for quantifying a rotational movement,
means for converting a quantified rotational movement into a displaying, on the display or monitor, of one or more characters, the character(s) displayed relating to the quantified rotational movement,
means for receiving an input selecting a displayed character and illustrating to the user the character selected and any previously selected characters.

In the present context, a string of characters may be a word, a sentence, a number, or any other sequence of characters. A character will normally be an alpha numeric character as defined in word processor systems. Thus, a character may be a letter (in any alphabet), a symbol, or a number. Normally, a character is a single letter, symbol or number.

The display or monitor may be based on any technology, such as CRT, LED, LCD or the like. In addition, the display or monitor may be a touch pad or screen adapted to receive information or engagements from the user. In fact, the rotational movement may be a movement detected on a touch pad.

In the present context, the displaying of one or more characters may be the distinguishing of the character(s) in relation to other characters simultaneously displayed on the monitor/display. This may be obtained by bolding the character(s), changing a font thereof, a colour thereof, a size thereof, a background thereof and/or a position thereof on the monitor/display. Alternatively, the character(s) displayed on the monitor may be replaced during rotation so that the character(s) on the monitor/display is/are that/those selected at the input. Naturally, these two types of embodiments may be mixed so that, during rotation, both the overall characters displayed on the monitor/display are changed and so that part of the character(s) displayed are distinguished from other displayed characters.

In addition, the monitor/display may be controlled to display the previously selected characters. This is especially desirable when writing messages or entering numbers in e.g. a telephone. Naturally, different areas of the monitor/display may be used for the displaying of character(s) to be selected and previously selected characters.

The quantifying means normally will quantify the rotational movement as an angle of rotation. However, this will depend on the manner in which the movement is detected.

In general, it is desired that a predetermined order exists between the characters and that the quantified rotation is correlated to a number of characters, so that the same quantified rotation will replace one displayed character with a character a predetermined number further along (or in the opposite direction depending on the direction of rotation) the order. Reaching an end of the order of the characters may bring about simply the displaying of the last character(s) of the order or may bring about a searching at the other end of the order of the characters (roll-over from the end to the beginning of the order of characters).

The rotation preferably determines which character(s) to display in that the larger the rotation the farther away, in the order of the characters, will the next displayed character be.

In one embodiment, the quantifying means comprises a rotatable element engageable by the user, the quantification being a quantification of an amount of rotation of the rotatable element.

In another embodiment, the quantifying means comprises a touch sensitive surface, the quantification being a quantification of a detected touch. The quantification determined may be made in a number of manners. The touch may be required to be around a predetermined point on the surface, and the rotation may be quantified as an angle from the beginning of the detected touch to the end thereof and around the point. Alternatively, no such requirement may be made, and the rotation may be quantified by fitting a circle to a determined touch curve on the surface, and the angle determined as an angle, seen from an origin of the circle and between the start and end of the touch curve.

In general, the quantification may be made with any desired precision, and the conversion for the determination, based on the rotation, of which character(s) to display may be made with any desired precision, such as a new character (preferably the next in the order of the characters) or set of characters is displayed for each e.g. 1, 2, 5, 7, 10, 15, 20, or 25 degrees of rotation.

The receiving means which the user uses to select a displayed (or distinguished) character may be any type of means, such as a touch button or a particular type of touch (such as a short tap) on a touch sensitive area.

In a particularly interesting embodiment:

the converting means is adapted to display one of a plurality of groups of characters on the monitor or display, the group displayed relating to the quantified rotational movement, and

the receiving means is adapted to receive an input specifying which character in the displayed group of characters is selected.

Thus, for each e.g. rotation unit, a group of characters is displayed instead of only a single character. In this manner, the desired character may be found using a lower rotational angle. Then, on the other hand, it is required that the receiving means are adapted to receive not only an input that the group is selected but which character in the group is desired.

In one situation, the receiving means is adapted to perform this task in that it comprises a touch sensitive element and is adapted to receive an input comprising a number of consecutive engagements of the touch sensitive element, the number of engagements defining which character in the group is selected. Thus, if a push button or a touch screen is used, a number of engagements may be entered, the number identifying the character of the group of characters displayed. This may be operated in the same manner as when individual characters are entered on a standard cell phone today, where each push button is able to select one of 4-5 characters, and the number of engagements of the button determines which character is selected.

Naturally, the present apparatus may be adapted to react to an instruction comprising the generated string of characters. If the apparatus was a telephone, a number entered as the string of characters may be called up or an SMS or MMS comprising the string may be transmitted. In addition, any apparatus comprising a processor may interpret the string of characters and act accordingly.

In another aspect, the invention relates to a method of generating a string of characters, the method comprising:
quantifying a rotational movement,
converting the quantified rotational movement into a displaying, on a display or monitor, of one or more characters, the character(s) displayed relating to the quantified rotational movement,
receiving an input selecting a displayed character and illustrating to the user the character selected and any previously selected characters.

As mentioned above, the receiving step preferably comprises controlling the monitor or display to display the selected character and any previously selected characters.

Also, in a first embodiment, the quantifying step comprises quantifying an amount of rotation of a rotatable element engageable by the user.

In another embodiment, the quantifying step comprises quantifying a detected touch on a touch sensitive surface. This detected touch may be required to be around a predetermined position on the surface in order to facilitate the quantification. Alternatively, the quantification may be related to a curve to which the touch on the surface is fitted.

As is also indicated above, the receiving step may be one or more activations of a touch button or a detection of a particular type of touch (e.g. a short tap) on a touch sensitive area.

In a particularly interesting embodiment:

the converting step comprises displaying one of a plurality of groups of characters on the monitor or display, the group displayed relating to the quantified rotational movement, and

the receiving step comprises receiving an input specifying which character in the displayed group of characters is selected.

In that embodiment, preferably the receiving step comprises receiving, as the input, a number of consecutive engagements of a touch sensitive element, the number of engagements defining which character in the group is selected.

Again, this method may be carried out by an apparatus adapted to also react to an instruction comprising the generated string of characters.

In another aspect, the invention relates to an apparatus for providing information to a user, the apparatus comprising:
a monitor or display for displaying the information to the user,
means for quantifying an angle of rotation of the apparatus,
means for rotating the information displayed on the monitor or display and in relation to the monitor or display by an angle relating to the angle of rotation.

The present aspect relates mainly to handheld apparatus which are normally rotated and moved about in a manner so that the reading or understanding of the information provided thereby is made difficult. The present aspect offers a solution to that problem.

Normally, a rotation of the information on the monitor/display is a rotation of an image provided by the monitor/display. Software adapted to perform this rotation is widely available. However, if a rotation outside the plane of the monitor/display is desired, this is feasible (however only to a limited extend due to the extent of the monitor or display) using the technology seen e.g. in handball fields where advertisements are glued to the floor of the arena. These advertisements seem, from the angle of the camera, to be of the correct rotation (trademarks are not stretched or deformed), whereas the text/images/trademarks of actual advertisements have been deformed due to the angle of viewing these being different from the angle perpendicular to the floor. This deformation is easily calculated and may be used to provide what seems to be a rotation out of the plane of the display or monitor.

In general, the rotation determination may be a static determination, such as a determination in relation to a fixed coordinate system or axis, or a relative determination, such as a a quantification of a rotation having taken place since the last rotation of the information on the monitor/display.

Thus, the rotation of the apparatus may be constantly monitored and taken into account by rotation of the information on the monitor/display.

In one situation, the quantifying means are adapted to determine and quantify rotation in a predetermined plane of the apparatus. In one situation, this would be in a plane of the monitor/display in that this is the plane in which the monitor/display is best able to rotate the information displayed thereby. It is possible, using imaging software, to actually rotate information provided by the monitor also in other planes, but only to a lower degree.

In one embodiment, the rotation is determined in relation to a well-defined, such as a static, axis. An example of this would be where the quantifying means comprises:

means for determining an orientation of the force of gravity, and

means for comparing a predetermined axis of the apparatus and a determined orientation of the force of gravity and for quantifying changes in the relation between the predetermined axis and the orientation.

Another example would be to determine the rotation in relation to an external magnetic/electric field, such as the earths magnetic field.

In general, gyros exist that are able to determine rotation in any plane and around any axis, so that all possibilities are open.

In one embodiment, the rotation of the information on the monitor/display is a rotation counteracting the rotation of the apparatus so that, to as large a degree as feasible, the information on the monitor/display is not rotated even though the apparatus is. Thus, it may be attempted to maintain a general axis of the displayed information in the same overall direction in relation to the surroundings of the apparatus.

In one situation, it may be desired to have a means for overriding the determining means. In this manner, it will be possible to activate this manner and then rotate the apparatus while it keeps the information provided still in relation to the apparatus. This may be used for resetting the direction of the information. This is especially interesting if the rotation is determined in a relative manner.

In a last aspect, the invention relates to a method of providing information to a user, the method comprising:

displaying the information to the user,

rotating the apparatus,

quantifying an angle of rotation of the apparatus,

rotating the information displayed on the monitor or display and in relation to the monitor or display at by angle relating to the angle of rotation.

As mentioned, the quantification step may be a quantification of a rotation since the last rotation of the information displayed.

In addition, the angle quantified may be in a predetermined plane or around a predetermined axis.

In one situation, the quantifying step comprises

determining an orientation of the force of gravity (or an external magnetic/electric field), and

comparing a predetermined axis of the apparatus and a determined orientation of the force of gravity and quantifying changes in the relation between the predetermined axis and the orientation.

In another situation, the quantifying step comprises quantifying rotation in a predetermined plane of the apparatus, such as a plane of the display/monitor.

Finally, the method may further comprise the step of overriding the quantifying step.

In the following, preferred embodiments of the invention will be described with reference to the drawing, wherein

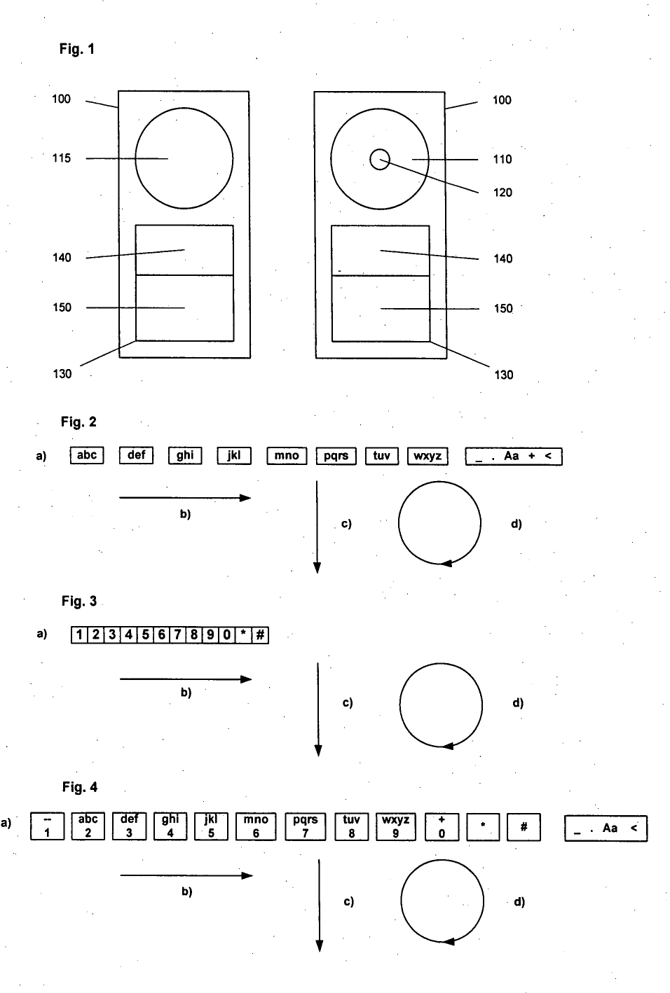

FIG. 1 illustrates two embodiments of the apparatus according to the invention,

FIGS. 2-4 illustrate different manners of entering characters into the apparatus,

FIG. 5 illustrates another embodiment of the apparatus according to the invention, and

FIG. 6 illustrates a block diagram of the contents of the apparatus of FIG. 5.

In FIG. 1, two embodiments 100 are described which are very similar to each other. The left apparatus 100 comprises a round sensing element 115 and a display 130 divided into two displays 140 and 150. One of the displays is used for displaying selectable characters to the user and the other display is used for displaying to the user all selected characters forming a string of characters.

The right apparatus has the same display 130/140/150 and as a round sensing element 110 having a center button 120.

The round elements 110 and 115 may be touch sensitive surfaces or a round wheel or element for the user to rotate.

If the elements 110/115 are touch sensitive elements, the rotation will be quantified on the basis of the difference between the starting and ending points of the touch of the user on the touch sensitive surface 110/115.

When entering a character, the user will start by engaging the element 110/115 and perform a rotational movement in order to either identify a character or a group of characters from which one character is to be selected.

In FIGS. 2-4, different manners of entering characters is illustrated.

In FIG. 2, a number of groups of characters are illustrated in the boxes, illustrated by a), are positioned in a horizontal row illustrated by b). An order of the groups is illustrated by the boxes position along the row.

Alternatively, the groups could be aligned vertically as illustrated by c) or in a circle as illustrated by d). Naturally, these different manners could be mixed so that the groups are positioned in a number of horizontal lines, e.g.

During rotation of the element 110/115, different ones of the groups a) will be displayed on the display 130/140 or will be highlighted if all or more of the groups are displayed simultaneously. Rotation in one direction will facilitate displaying of the groups in one direction along the order b), c), or d), depending on the orientation of the groups, and vice versa.

Having rotated the element 110/115 so that the correct group is displayed/highlighted, selection of the correct character therein is to be performed.

This selection may be performed as is seen today in mobile telephones by engaging either the button 120 or the element 110/115 a number of times corresponding to the number of the desired character in the group. Thus, selecting a “h” will require the rotation of the element 110/115 until the group “hgi” is displayed/highlighted, and the subsequent engagement twice of the button 120 or element 110/115.

An alternative to the use of groups is seen in FIG. 3 in which the selection of a number requires rotation until the desired number is displayed/highlighted. Selection may then be obtained by a single engagement of the button 120 or element 110/115. Alternatively, the numbers 1-0 may be provided as a single group, whereby selecting a “5” will require the displaying of the group and 5 subsequent engagements of 120/110/115.

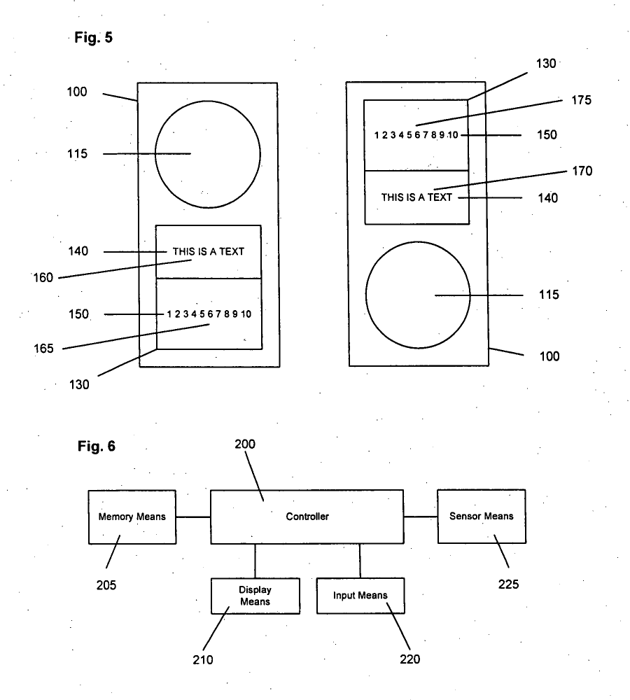

In FIG. 4, an embodiment is seen in which the numbers are introduced into the groups of the letters.

Naturally, any grouping may be chosen, including the embodiment in which only a single letter/number/sign/character is displayed/highlighted at the time so that the selection thereof is simple.

The detection of the rotation may be performed quite simply, if the element 110/115 is a physically rotatable wheel or element.

If the element 110/115 is a touch screen/pad, the rotation may be determined as a rotation around a predetermined central point of the pad 110/115 or around an axis or point of the pad 110/115 determined from the determined pattern or curve of the touch. An example would be to fit a part of a circle to the determined curve and determine the rotation around an origin of the fitted circle.

Naturally, the apparatus 100 may be a mobile telephone, a PDA, a pocket calendar or the like adapted to act on the string of characters entered.

Also, the apparatus 100 may additionally comprise further buttons or may be adapted to interpret engagements of a touch sensitive surface for other purposes, such as deleting selected characters, selecting a spell check facility, navigating in the selected string for introduction or removal of characters therein or the like.

FIG. 5 illustrates another embodiment which is able to determine a rotation of the apparatus. If this rotation exceed a predetermined degree, the information provided on the display may be rotated.

In FIG. 5 a simple embodiment is illustrated in which the apparatus 100 is rotated 180 degrees, which the apparatus will detect and therefore also rotate the information provided in the displays 130 and 140 by 180 degrees. In this manner, the user will be able to determine the information displayed irrespective of the rotation.

FIG. 6 illustrates the components of the embodiment of FIG. 5. It is seen that a controller 200 controls a memory means 205 storing both the program for the controller as well as the string of previously selected characters. In addition, the controller 200 controls the display means in order to display both the character(s) to be selected and those already selected. The controller 200 also controls or interacts with the input means 220 which comprise the element 110/115 and any other input elements, such as the button 120. Finally, the controller 200 receives information from a sensor 225 adapted to sense and quantify rotation of the apparatus.

The sensor 225 may comprise a gyro adapted to provide information regarding a relative rotation (rotation since the last read-out) or information regarding the apparatus' rotation in relation to a fixed axis or coordinate system, such as in relation to an orientation of the force of gravity or external magnetic/electric fields.

The rotation of the information on the display 130 may solely be in the plane of the display 130 as is illustrated in FIG. 5. In this manner, only rotation in that plane may be taken into account, or the rotation determined may be projected onto that plane, and only the component in that plane may be quantified and taken into account. In this manner, the information need only be rotated on the display.

Alternatively, the rotation may also be determined and corrected out of the plane of the display. In this manner, the actual information of the display may also be altered, such as deformed from its initial shape, in order to seem rotated out of the plane of the display.

1. Apparatus for a user to generate a string of characters, the apparatus comprising:
a display or monitor for providing information to the user,
means for quantifying a rotational movement,
means for converting a quantified rotational movement into a displaying, on the display or monitor, of one or more characters, the character(s) displayed relating to the quantified rotational movement,
means for receiving an input selecting a displayed character and illustrating to the user the character selected and any previously selected characters.

2. An apparatus according to claim 1, wherein the receiving means is adapted to control the monitor or display to display the selected character and any previously selected characters.

3. An apparatus according to claim 1, wherein the quantifying means comprises a rotatable element engageable by the user, the quantification being a quantification of an amount of rotation of the rotatable element.

4. An apparatus according to claim 1, wherein the quantifying means comprises a touch sensitive surface, the quantification being a quantification of a detected touch.

5. An apparatus according to claim 1, wherein:
the converting means is adapted to display one of a plurality of groups of characters on the monitor or display, the group displayed relating to the quantified rotational movement, and
the receiving means is adapted to receive an input specifying which character in the displayed group of characters is selected.

6. An apparatus according to claim 5, wherein the receiving means comprises a touch sensitive element and is adapted to receive an input comprising a number of consecutive engagements of the touch sensitive element, the number of engagements defining which character in the group is selected.

7. A method of generating a string of characters, the method comprising:
quantifying a rotational movement,
converting the quantified rotational movement into a displaying, on a display or monitor, of one or more characters, the character(s) displayed relating to the quantified rotational movement,
receiving an input selecting a displayed character and illustrating to the user the character selected and any previously selected characters.

8. A method according to claim 7, wherein the receiving step comprises controlling the monitor or display to display the selected character and any previously selected characters.

9. A method according to claim 7, wherein the quantifying step comprises quantifying an amount of rotation of a rotatable element engageable by the user.

10. A method according to claim 7, wherein the quantifying step comprises quantifying a detected touch on a touch sensitive surface.

11. A method according to claim 7, wherein:
the converting step comprises displaying one of a plurality of groups of characters on the monitor or display, the group displayed relating to the quantified rotational movement, and
the receiving step comprises receiving an input specifying which character in the displayed group of characters is selected.

12. A method according to claim 11, wherein the receiving step comprises receiving, as the input, a number of consecutive engagements of a touch sensitive element, the number of engagements defining which character in the group is selected.

13. An apparatus for providing information to a user, the apparatus comprising:
a monitor or display for displaying the information to the user,
means for quantifying an angle of rotation of the apparatus,
means for rotating the information displayed on the monitor or display and in relation to the monitor or display by an angle relating to the angle of rotation.

14. An apparatus according to claim 13, wherein the quantifying means comprises
means for determining an orientation of the force of gravity, and
means for comparing a predetermined axis of the apparatus and a determined orientation of the force of gravity and for quantifying changes in the relation between the predetermined axis and the orientation.

15. An apparatus according to claim 13, wherein the quantifying means are adapted to determine and quantify rotation in a predetermined plane of the apparatus.

16. An apparatus according to claim 13, further comprising a means for overriding the determining means.

17. A method of providing information to a user, the method comprising:
displaying the information to the user,
rotating the apparatus,
quantifying an angle of rotation of the apparatus,
rotating the information displayed on the monitor or display and in relation to the monitor or display by an angle relating to the angle of rotation.

18. A method according to claim 17, wherein the quantifying step comprises
determining an orientation of the force of gravity, and
comparing a predetermined axis of the apparatus and a determined orientation of the force of gravity and quantifying changes in the relation between the predetermined axis and the orientation.

19. A method according to claim 17, wherein the quantifying step comprises quantifying rotation in a predetermined plane of the apparatus.

20. A method according to claim 17, further comprising the step of overriding the quantifying step.
